(19) United States
(12) Patent Application Publication
(10) Pub. No.: US 2018/0045584 A1
(43) Pub. Date: Feb. 15, 2018

(54) Systems and Methods of Sensor Linearization

(71) Applicant: Google Inc., Mountain View, CA (US)

(72) Inventor: Enrique Romero Pintado, Campbell, CA (US)

(21) Appl. No.: 15/235,307

(22) Filed: Aug. 12, 2016

(51) Int. Cl. G01K 15/00

(52) U.S. Cl. CPC G01K 15/005

(57) ABSTRACT

Systems and methods of sensor linearization are provided. For instance, a system for sensing a value associated with a physical quantity can include a sensing network including a transducer, a source configured to provide an electrical signal to the sensing network, and an analog-to-digital converter coupled to the transducer configured to sample an output voltage associated with the sensing network. The system can further include one or more processors configured to determine a value of a physical quantity associated with the system based at least in part on the sampled output voltage associated with the sensing network. The value of the physical quantity is determined based at least in part on a linear approximation of a network characteristic associated with the sensing network. The linear approximation is determined by approximating a slope of a tangent of a selected point on the network characteristic to a power of two.

### FIELD

The present disclosure relates generally to linearization techniques for sensing physical quantity values.

### BACKGROUND

Transducers can be used to convert one form of energy to another. For instance, transducers can be used to convert electrical signals to and from other physical quantities (e.g. energy, force, torque, light, motion, position, temperature, etc.). In particular, a value of an input physical quantity associated with a transducer can be determined based on an output signal associated with the transducer. As an example, temperature dependent transducers called thermistors can exhibit changes in resistance based on changes in temperature of the thermistors. In this manner, temperatures associated with the thermistor can be determined based at least in part on the resistance of the thermistor at a particular time.

The resistance vs. temperature characteristic of thermistors is often exponential and nonlinear. In addition, a voltage vs. temperature characteristic associated with a sensing network having a thermistor and one or more components directly or indirectly coupled to the thermistor is also often exponential and nonlinear. Similarly, output characteristics associated with other transducers can also be exponential and/or nonlinear. Such nonlinear output characteristics can create difficulties in sensing physical quantity values associated with the transducers. Transducer linearization techniques can be used to more easily sense the associated physical quantity value by configuring a sensing network in various manners to provide a linearized output characteristic. Such sensing networks can include logarithmic amplifiers, pulse generators, analog multipliers, timing circuits, delta-sigma analog-to-digital converters (ADCs), dual-slope ADCs, etc. arranged in various suitable manners with respect to a thermistor or other transducer.

In addition, transducer linearization techniques can further include defining a linear approximation of an output characteristic over a range of values, such that the physical quantity value can be estimated based at least in part on the linear approximation. For instance, in some implementations, such linear approximation techniques can include finding a tangent line of the output characteristic at a selected point along the output characteristic, such that the tangent line approximates the output characteristic over a range of physical quantity values.

### SUMMARY

Aspects and advantages of embodiments of the present disclosure will be set forth in part in the following description, or may be learned from the description, or may be learned through practice of the embodiments.

One example aspect of the present disclosure is directed to a system for sensing a value associated with a physical quantity. The system includes a sensing network including a transducer. The system further includes a source configured to provide an electrical signal to the sensing network. The system further includes an analog-to-digital converter coupled to the transducer. The analog-to-digital converter is configured to sample an output voltage associated with the sensing network. The system further includes one or more processors configured to determine a value of a physical quantity associated with the system based at least in part on the sampled output voltage associated with the sensing network. The value of the physical quantity is determined based at least in part on a linear approximation of a network characteristic associated with the sensing network. The linear approximation is determined by approximating a slope of a tangent of a selected point on the network characteristic to a power of two.

Another example aspect of the present disclosure is directed to a method of linearizing a network characteristic associated with a sensing network. The method includes applying, by a source, an electrical signal to a sensing network, the sensing network comprising a thermistor. The method further includes converting, by an analog-to-digital converter operatively coupled to the sensing network, an output voltage associated with the sensing network to a digital representation of the output voltage. The method further includes determining, by one or more processors, a temperature value associated with the thermistor based at least in part on a linear approximation of a network characteristic associated with the sensing network. The linear approximation of the network characteristic is determined by approximating a slope of a tangent line of a selected point on the network characteristic to a power of two.

Other example aspects of the present disclosure are directed to systems, apparatus, tangible, non-transitory computer-readable media, user interfaces, memory devices, and electronic devices for linearizing transducer characteristics.

These and other features, aspects and advantages of various embodiments will become better understood with reference to the following description and appended claims.

The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system for sensing a value of a physical quantity according to example embodiments of the present disclosure.

FIG. 2 depicts an example sensing network according to example embodiments of the present disclosure.

FIG. 3 depicts a plot of an example network characteristic according to example embodiments of the present disclosure.

FIG. 4 depicts a plot of example linear approximations of the network characteristic according to example embodiments of the present disclosure.

FIG. 5 depicts a plot of example temperature errors associated with the example linear approximations according to example embodiments of the present disclosure.

FIG. 6 depicts a flow diagram of an example method of sensing a value of a physical quantity according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to systems and methods for detecting physical quantities using a sensing network. For instance, the sensing network can include a transducer. The transducer can be any suitable transducer configured to respond directly or indirectly to a physical quantity. For instance, the transducer can be a thermistor (e.g. negative temperature coefficient (NTC) thermistor), pressure sensor (e.g. piezoresistive pressure sensor), light dependent resistor (e.g. photoresistor), sound dependent sensor, strain gauge, thermocouple, resistance thermometer, potentiometer, and/or other suitable transducer. The sensing network can convert the physical quantity to an electrical signal in accordance with a predefined network characteristic. The network characteristic can define a relationship between the physical quantity and the electrical signal. For instance, in implementations wherein the transducer is a thermistor, the physical quantity can be temperature and the electrical signal can be a resistance or voltage associated with the thermistor.

The sensing network can further include at least a linearizing resistor coupled to the transducer (e.g. in parallel or series). In some implementations, the sensing network can further include one or more additional components or devices, such as one or more additional resistors, operational amplifiers, capacitors, inductors, diodes, and/or other suitable components or devices. The sensing network can be configured in various suitable manners. The sensing network can receive an electrical signal from a source (e.g. voltage source or current source). The source can be configured to provide an electrical signal to the transducer. An output voltage associated with the sensing network can be determined, and a value of the physical quantity can be determined based at least in part on the output voltage. For instance, in some implementations, the output voltage can correspond to a voltage drop across the transducer when the electric signal is applied to the sensing network by the source. The value of the physical quantity can be determined by correlating the output voltage to a value of the corresponding physical quantity based at least in part on the network characteristic. In some implementations, the output voltage can be sampled and digitized using one or more analog-to-digital converters (ADCs) and the digitized voltage can be correlated to the value corresponding of the corresponding physical quantity.

According to example aspects of the present disclosure, the value of the physical quantity can be determined based at least in part on a linear approximation of the network characteristic. As will be understood by those skilled in the art, a tangent line of a function can be used as a linear approximation of the function over some range of values. The linearized function determined according to example aspects of the present disclosure can have a slope corresponding to a slope of the tangent line rounded to a power of two. For instance, the slope of the tangent can be rounded to the nearest power of two. In this manner, the linear approximation can be determined by approximating a slope of a tangent of a selected point associated with the network characteristic to the nearest power of two. The selected point can be selected based at least in part on a desired range of the physical quantity. In this manner, the selected point can correspond to a value of the physical quantity within the desired range of values. For instance, the selected point can correspond to a value substantially in the center of the desired range of values. In some implementations, the selected point associated with the network characteristic can be a point of inflection associated with the network characteristic. For instance, the network characteristic can be a nonlinear function that includes a concave portion and a convex portion. In this manner, the network characteristic function can include a point of inflection substantially at a point on the function where the concavity changes.

As indicated, in some implementations, the sensing network can be coupled to an ADC configured to sample an output voltage associated with the sensing network. The ADC can convert the sampled output voltage to the digital domain and can provide the digitized voltage to one or more processors associated with the sensing network. The one or more processors can then determine the physical quantity value corresponding to the digitized voltage based at least in part on the linear approximation. As will be described in more detail below, in such implementations, the linear approximation can be defined based at least in part on the sampled output voltage.

The linearized function of the present disclosure can provide for smaller errors between the linearized function and the network characteristic relative to a linearization using the actual tangent over the desired range of values. In addition, the linear approximation of the present disclosure can be configured to facilitate simple, efficient signal processing by one or more processors configured to correlate the output voltage (e.g. the sampled, digitized output voltage) to a particular value of the physical quantity. In particular, the linear approximation can be configured to allow the correlation to be determined using one or more logic bit shift operations and/or one or more addition operations performed by the one or more processors. In this manner, by approximating the slope of the tangent to the nearest power of two, the linear approximation can be configured to include a power of two division operation (e.g. that can be implemented using the one or more bit shift operations by the one or more processors), and/or an addition operation of an offset value determined according to example aspects of the present disclosure. The linear approximation can avoid the need for multiplication and/or division algorithms that can be intensive from an area standpoint in Silicon and a resource standpoint in software and/or hardware.

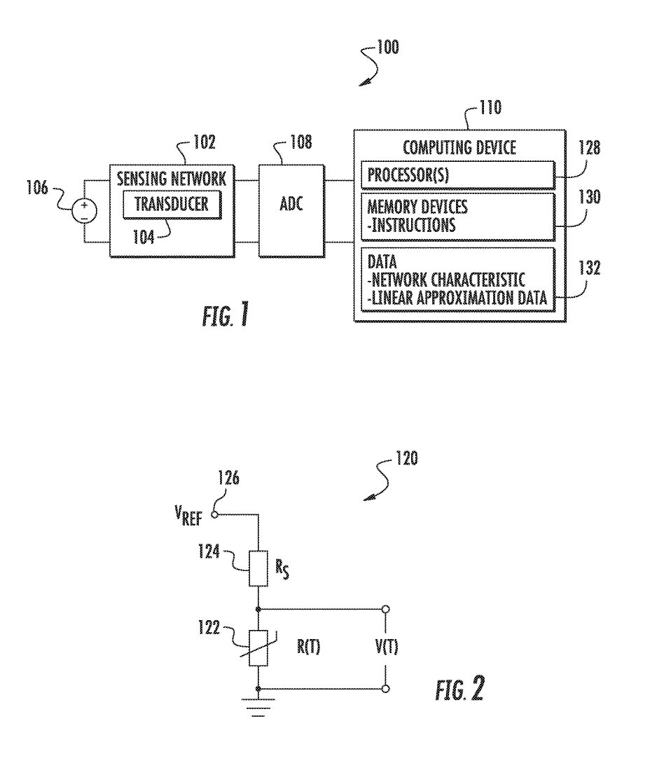

With reference now to the figures, example aspects of the present disclosure will be discussed in greater detail. For instance, FIG. 1 depicts an overview of an example system 100 for sensing a value of a physical quantity according to example embodiments of the present disclosure. System 100 includes a source 106 and a sensing network 102. The source 106 can be any suitable source, such as a voltage source or a current source. The source 106 can be configured to apply an electrical signal to the sensing network 102. The sensing network 102 can be any suitable sensing network. In particular, the sensing network 102 can include a transducer 104. Transducer 104 can be any suitable transducer, such as a thermistor, pressure sensor, photoresistor, sound dependent sensor, strain gauge, thermocouple, resistance thermometer, potentiometer, and/or other suitable transducer. In some implementations, the sensing network 102 can include one or more components coupled directly or indirectly to the transducer 104. For instance, the sensing network 102 can include one or more resistors, capacitors, inductors, diodes, operational amplifiers, and/or other suitable components. The one or more opponents of the sensing network 102 can be arranged in various suitable manners.

In one particular implementation, the transducer 104 can be an NTC thermistor. For instance, FIG. 2 depicts an example sensing network 120 according to example embodiments of the present disclosure. Sensing network 120 depicts a thermistor 122 (R(T)) coupled in series to a linearizing resistor 124 (R_{S}). The thermistor 122 and the linearizing resistor 124 are coupled to a voltage source 126 (V_{REF}). Source 126 can apply a voltage to the linearizing resistor 124 and the thermistor 122. A network characteristic associated with sensing network 120 can define a relationship between an output voltage V(T) corresponding to a voltage drop across the thermistor 122 and temperature of the thermistor 122. In this manner, V(T) can be a voltage that is a function of temperature (e.g. in degrees Celsius). V(T) can be defined as follows:

$$V ( T ) = \frac{{V}_{REF} \cdot {R}_{th} ( T )}{{R}_{th} ( T ) + {R}_{s}}$$

wherein T is the temperature in degrees Celsius, and Rₜₕ(T) is the characteristic that describes the resistance over temperature of thermistor 122. As will be understood by those skilled in the art, Rₜₕ(T) can be highly nonlinear and exponential in nature. In particular, Rₜₕ(T) can be related to absolute temperature as follows:

$${R}_{th} ( T ) = {R}_{0} \cdot {e}^{[ β \cdot ( \frac{1}{( T + 273.15 )} - \frac{1}{( {T}_{0} + 273.15 )} ) ]}$$

wherein R₀ is the resistance at a specific reference temperature (e.g. Rₜₕ(T=T₀) where T₀ is typically 25 degrees Celsius. β can be a value given by the manufacturer of thermistor 122 that depends on the fabrication material and resistance of the thermistor 122.

It will be appreciated that the sensing network 122 is discussed for illustrative purposes. In particular, it will be appreciated that various other suitable sensing networks can be used. For instance, in some implementations, the thermistor can be positioned above the linearizing resistor with respect to the source. In such implementations, V(T) can be a voltage drop across the linearizing resistor, and can be represented as follows:

$$V ( T ) = \frac{{V}_{REF} \cdot {R}_{s}}{{R}_{th} ( T ) + {R}_{s}}$$

As another example, the thermistor can be coupled in parallel with the linearizing resistor. In such implementations the source can be a current source, and V(T) can be represented as follows:

$$V ( T ) = \cdot {R}_{//} = \frac{{I}_{REF} \cdot {R}_{th} ( T ) \cdot {R}_{s}}{{R}_{th} ( T ) + {R}_{s}}$$

Referring back to FIG. 1, sensing network 102 can be coupled to an ADC 108. ADC 108 can be any suitable ADC. ADC 108 can be configured to sample the output voltage 17(T) using various suitable sampling techniques or schemes. ADC 108 can further be configured to convert the sampled output voltage into the digital domain, and to provide the digitized voltage to a computing device 110. Although ADC 108 and computing device 110 are depicted as separate components in FIG. 1, in some implementations, ADC 108 can be implemented within computing device 110. Computing device 110 can be configured to determine a value of the physical quantity associated with the transducer 104 that corresponds to the output voltage. In particular, computing device 110 can be configured to determine the value of the physical quantity based at least in part on a network characteristic associated with the sensing network 102. As indicated, the network characteristic can define a relationship between V(T) and the physical quantity (e.g. temperature). The computing device 110 can access linear approximation data determined based at least in part on a linearization scheme determined according to example aspects of the present disclosure. For instance, the linearization scheme can include approximating the slope of the tangent line of the network characteristic function at a particular point on the network characteristic function to find a linearized function. In particular, the approximation can include rounding the slope of the tangent line to the nearest power of two. In some implementations, the linearized function can be another suitable linear function that has a power of two slope. For instance, the linear function can be determined without reference to the tangent of the network characteristic function at the particular point.

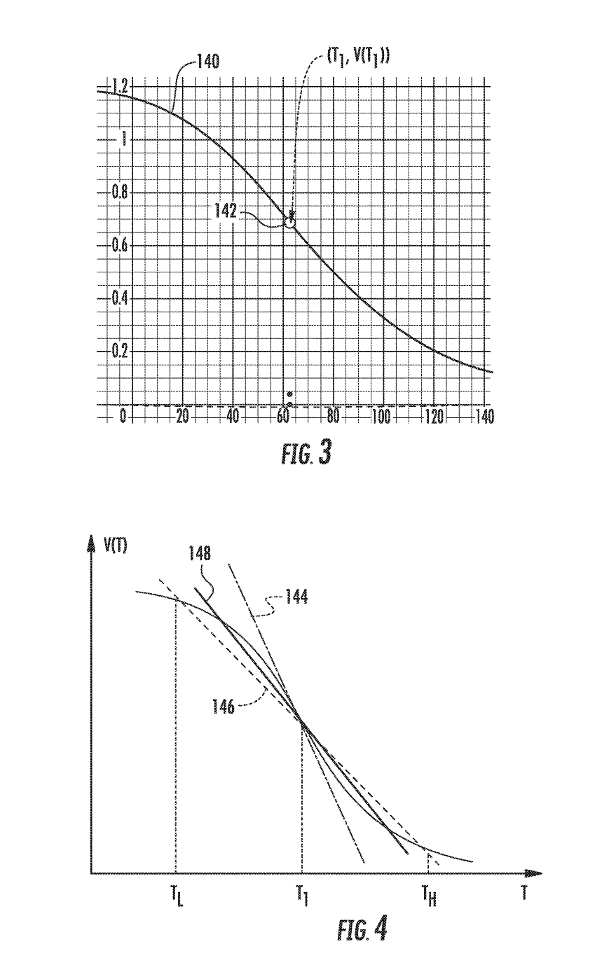

FIG. 3 depicts a plot of an example network characteristic 140 according to example embodiments of the present disclosure. Network characteristic 140 can define a relationship between the output voltage V(T) of sensing network 120 of FIG. 2 and the temperature T of the thermistor 122. As shown, network characteristic 130 is a nonlinear function that includes a concave portion and a convex portion. Network characteristic 140 further includes a point of inflection 142 (T₁, V(T₁) corresponding to a point along network characteristic 140 where the concavity changes. In some implementations, the point of inflection 142 can be the selected point at which the linear approximation is determined.

As will be understood by those skilled in the art, the point of inflection can be determined by solving the equation:

V″(T)=0

T₁ can be the temperature at the point of inflection of the network characteristic 130. T₁ can be the approximate midpoint of the temperature range associated with the linear approximation. In this manner, the resistance R_{S} of the linearizing resistor 124 can determine the location of the curve with respect to the temperature T. In some implementations, R_{S} can be represented as follows:

$${R}_{s} = R ( {T}_{1} ) \cdot \frac{( β - 2 \cdot {T}_{1} )}{( β + 2 \cdot {T}_{1} )}$$

Referring back to FIG. 1, the computing device 110 can access the linear approximation data to determine the value of the physical quantity that corresponds to the output voltage associated with the sensing network 102. For instance, the computing device 110 can include one or more processors 128 and one or more memory device s 130. The one or more processors 128 can include any suitable processing device, such as a microprocessor, microcontroller, integrated circuit, logic device, or other suitable processing device. The one or more memory devices 130 can include one or more computer-readable media, including, but not limited to, non-transitory computer-readable media, RAM, ROM, hard drives, flash drives, or other memory devices. The one or more memory devices 130 can store information accessible by the one or more processors 128, including computer-readable instructions that can be executed by the one or more processors 128. The instructions can be any set of instructions that when executed by the one or more processors 128, cause the one or more processors 128 to perform operations. The one or more memory devices 130 can also store data 132 that can be retrieved, manipulated, created, or stored by the one or more processors 128. The data 132 can include, for instance, network characteristic data, linear approximation data, and other data.

According to example aspects of the present disclosure, the linear approximation data can be configured to facilitate a determination of the value of the physical quantity corresponding to the output voltage without the need for a performance of complex multiplication and/or division algorithms by the one or more processors 128, and without the need to access a lookup table or other data structure specifying the network characteristic by the one or more processors. In this manner, the value of the physical quantity can be determined through simple, efficient operations performed by the one or more processors 128. In particular, as will be described below, the linear approximation can be configured to facilitate determination of the value of the physical quantity through one or more bit shift operations by the one or more processors 128. As will be understood by those skilled in the art, the one or more bit shift operations can correspond to one or more operations of division by a power of two determined by the one or more processors. In addition, the linear approximation can be configured to allow for the value of the physical quantity to be determined using an addition operation by the one or more processors of an offset value determined according to example embodiments of the present disclosure.

FIG. 4 depicts a plot of example linearized functions determined based on one or more linear approximation schemes. In particular, FIG. 4 depicts linearized function 144, linearized function 146, and linearized function 148. The linearized functions 144-148 are associated with the point of inflection 142 of the network characteristic 140. Linearized function 144 is a tangent line of the network characteristic 144 at the point of inflection 142. The equation of the tangent line to V(T) at the point of inflection 142 can be represented as follows:

y=V′(T₁)(x−T₁)+V(T₁)

Linearized function 146 can be determined by selecting a straight line that crosses two “extreme” points (e.g. T_{L},T_{H}) of the network characteristic 140, one point on the concave portion of the network characteristic 140 and one point on the convex portion. The two “extreme” points can correspond to a desired range of temperatures around the point of inflection 142 that are considered for linearization.

The linearized function 148 is a linearized function determined according to example embodiments of the present disclosure. In particular, the linearized function 148 can be determined by approximating the slope of the tangent line to a power of two (e.g. the closest power of two), as follows:

$${V}^{′} ( {T}_{1} ) = - \frac{{V}_{REF}}{{2}^{k}}$$

where V_{REF} is the voltage reference of the ADC (e.g. ADC 108) that determines the full scale of the ADC. In this manner, the voltage applied to the sensing network 102 can be the same as the reference voltage for the ADC. In this manner, the measurements can be ratiometric, thereby eliminating or reducing variations on the reference voltage and/or drift errors.

Solving for k in the above equation can be performed as follows:

$${2}^{k} = - \frac{{V}_{REF}}{{V}^{′} ( {T}_{1} )}$$

$$k = {log}_{2} - \frac{{V}_{REF}}{{V}^{′} ( {T}_{1} )}$$

In some implementations, a floor function or a ceiling function can be applied to k, such that k is rounded to an integer. For instance, a ceiling function can be used in implementations when the network characteristic has a concave-downward to concave-upward configuration. In this manner:

$$k = ⌈ {log}_{2} - \frac{{V}_{REF}}{{V}^{′} ( {T}_{1} )} ⌉$$

Substituting the approximated slope of the tangent into the equation for the tangent of the network characteristic 140 at the point of inflection 142 can provide the following:

$$V ( T ) = \frac{- {V}_{REF}}{{2}^{⌈ {log}_{2} - \frac{{V}_{REF}}{{V}^{′} ( {T}_{1} )} ⌉}} ( T - {T}_{1} ) + V ( {T}_{1} )$$

$$V ( T ) = \frac{- {V}_{REF}}{{2}^{⌈ {log}_{2} - \frac{{V}_{REF}}{{V}^{′} ( {T}_{1} )} ⌉}} T + \frac{{V}_{REF}}{{2}^{⌈ {log}_{2} - \frac{{V}_{REF}}{{V}^{′} ( {T}_{1} )} ⌉}} {T}_{1} + V ( {T}_{1} )$$

In this manner, the above equation represents the linearized function 148. Solving for the temperature T can be accomplished as follows:

$$T = \frac{{2}^{⌈ {log}_{2} - \frac{{V}_{REF}}{{V}^{′} ( {T}_{1} )} ⌉}}{- {V}_{REF}} ( V ( T ) - \frac{{V}_{REF}}{{2}^{⌈ {log}_{2} - \frac{{V}_{REF}}{{V}^{′} ( {T}_{1} )} ⌉}} {T}_{1} - V ( {T}_{1} ) )$$

$$T = \frac{{2}^{⌈ {log}_{2} - \frac{{V}_{REF}}{{V}^{′} ( {T}_{1} )} ⌉}}{- {V}_{REF}} V ( T ) + ( {T}_{1} + \frac{{2}^{⌈ {log}_{2} - \frac{{V}_{REF}}{{V}^{′} ( {T}_{1} )} ⌉}}{{V}_{REF}} V ( {T}_{1} ) )$$

$$T = \frac{{2}^{⌈ {log}_{2} - \frac{{V}_{REF}}{{V}^{′} ( {T}_{1} )} ⌉}}{- {V}_{REF}} {V}_{ADC} ( T ) + nint ( {T}_{1} + \frac{{2}^{⌈ {log}_{2} - \frac{{V}_{REF}}{{V}^{′} ( {T}_{1} )} ⌉}}{{V}_{REF}} V ( {T}_{1} ) )$$

where V_{ADC}(T) is the sampled output voltage V(T) by the ADC. The expression can be simplified further by taking into account the least significant bit (LSB) associated with V_{ADC}(T):

$${V}_{ADC} ( T ) = {ADC}_{code} \cdot LSB = {ADC}_{code} \cdot \frac{{V}_{REF}}{{2}^{N}}$$

$$1 LSB = \frac{{V}_{REF}}{{2}^{N}} , N = number of ADC bits$$

$$T = \frac{{2}^{⌈ {log}_{2} - \frac{{V}_{REF}}{{V}^{′} ( {T}_{1} )} ⌉}}{- {V}_{REF}} {ADC}_{code} \cdot \frac{{V}_{REF}}{{2}^{N}} + nint ( {T}_{1} + \frac{{2}^{⌈ {log}_{2} - \frac{{V}_{REF}}{{V}^{′} ( {T}_{1} )} ⌉}}{- {V}_{REF}} V ( {T}_{1} ) )$$

$$T = \frac{{2}^{k}}{- {V}_{REF}} \cdot \frac{{V}_{REF}}{{2}^{N}} {ADC}_{code} + nint ( {T}_{1} + \frac{{2}^{k}}{- {V}_{REF}} V ( {T}_{1} ) )$$

$$where k = ⌈ {log}_{2} - \frac{{V}_{REF}}{{V}^{′} ( {T}_{1} )} ⌉ k ∈ ℕ thus$$

$$T = - \frac{{ADC}_{code}}{{2}^{N - k}} + nint ( {T}_{1} + \frac{{2}^{k}}{- {V}_{REF}} V ( {T}_{1} ) )$$

In this manner, the temperature T can be represented as follows:

T(° C.)=f(ADC_{code})+offs offsε

[symbol]

As shown, T can be determined by the one or more processors 128 by dividing the output voltage associated with the ADC (V_{ADC}) by a power of two (2^{k}), and adding an offset value to the quotient. As indicated, such operations can be performed by the one or more processors 128 using one or more bit shift operations and an addition operation. For instance, the number of bit shift operations required can depend on the value of k. In this manner, the one or more processors can determine the value of the physical quantity corresponding to the output voltage of a sensing network without the need to access a lookup table, or to perform complex calculations that can be time and/or resource intensive. Such efficient, simple calculations performed by the one or more processors 128 can reduce a time and/or amount of resources required to determine the value of the physical quantity.

As indicated above, the linearized function 148 determined according to example aspects of the present disclosure can further be a more accurate representation of the network characteristic 140 within the desired range of values relative to the linearized functions 144 and 146. For instance, FIG. 5 depicts example temperature error plots 150, 152, and 154 respectively associated with linearization functions 144-148. Temperature error plots 150-154 specify a difference between the network characteristic 140 and the respective linearization functions 144-148 within the considered range of values.

In particular, temperature error plot 150 specifies a temperature error associated with linearization function 144 (e.g. the tangent). As shown by plot 150, linearization function 144 provides the least accurate linearization of the considered linearized functions. Temperature error plot 152 corresponds to linearization function 146, and temperature error plot 154 corresponds to linearization function 148. As shown by plots 152 and 154, the linearization function 148 provides the most accurate linearization of the considered linearization functions. In this manner, linearization function 148 determined according to example aspects of the present disclosure can be implemented more efficiently, and can provide more accurate results relative to linearization functions 144 and 146.

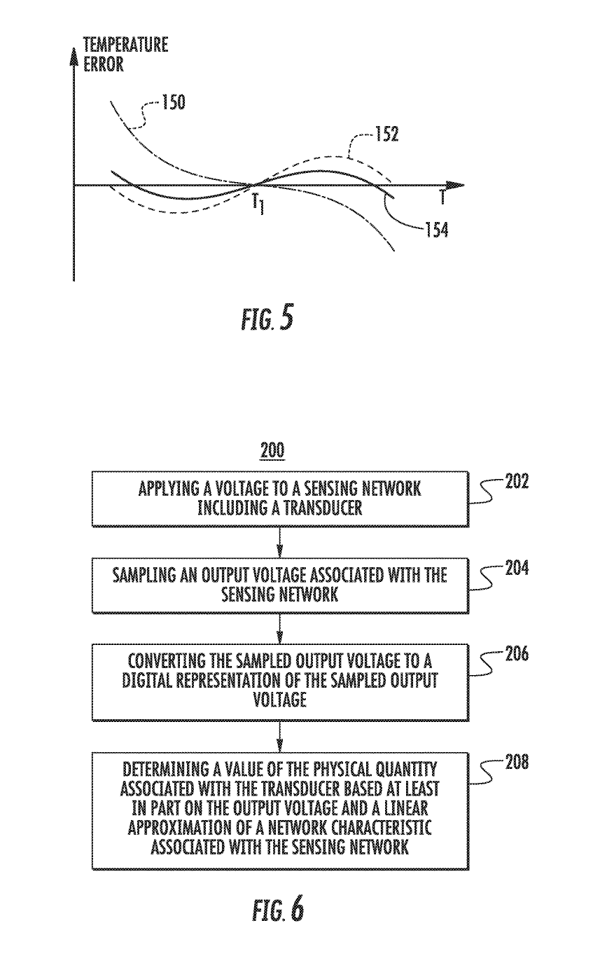

FIG. 6 depicts a flow diagram of an example method (200) of sensing a value of a physical quantity according to example embodiments of the present disclosure. Method (200) can be implemented by one or more computing devices, such as one or more of the computing devices depicted in FIG. 1. In addition, FIG. 6 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (202), method (200) can include applying a voltage to a sensing network. The sensing network can include a transducer (e.g. thermistor, pressure sensor (e.g. piezoresistive pressure sensor), light dependent resistor (e.g. photoresistor), sound dependent sensor, strain gauge, thermocouple, resistance thermometer, potentiometer, and/or other suitable transducer). The sensing network can further include one or more components or devices directly or indirectly coupled to the transducer. For instance, the one or more components can include a linearizing resistor coupled in parallel or series with the transducer. In this manner, the transducer and the components of the sensing network can be arranged or configured in various suitable manners to provide a suitable network characteristic specifying a relation between a physical quantity associated with the transducer and an electrical voltage or resistance (or other suitable electrical signal) associated with the sensing network.

At (204), method (200) can include sampling an output voltage associated with the sensing network. In some implementations, the output voltage can be a voltage corresponding to a voltage drop across the transducer when an electrical signal is applied to the sensing network by a source associated with the sensing network. In some implementations, the output voltage can be a voltage corresponding to a voltage drop across one or more of the other components of the sensing network. In particular, the output voltage can be sampled by a suitable ADC operatively coupled to the sensing network using various suitable sampling techniques and/or various suitable sampling frequencies.

At (206), method (200) can include converting the sampled output voltage to the digital domain by determining a digital representation of the sampled output voltage. As will be understood by those skilled in the art, various suitable ADCs can be used to sampled and/or digitize the output voltage, and the various suitable ADCs can be configured to use various suitable conversion techniques.

At (208), method (200) can include determining a value of the physical quantity associated with the transducer based at least in part on the output voltage. The value of the physical quantity can be determined based at least in part on the network characteristic associated with the sensing network. In particular, the value of the physical quantity can be determined based at least in part on a linear approximation of the network characteristic in accordance with various aspects of the present disclosure. The linear approximation can be determined by approximating the slope of the tangent of the network characteristic function at a selected point to the nearest power of two. In some implementations, the selected point can be an inflection point associated with the network characteristic. In some implementations, the selected point can be a different point of the network characteristic function.

As indicated above, the linear approximation can facilitate a determination of the value of the physical quantity through one or more logic bit shift operations and an addition operation of an offset value. In this manner, the output of the ADC can be provided to one or more processors, and the one or more processors can determine the value of the physical quantity using the one or more bit shift operations and the addition operation. Such operations can be performed using a small amount of the signal processing resources, and can increase the speed and efficiency with which the value of the physical quantity can be found.

The technology discussed herein makes reference to computing systems, which can include servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, computing processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A system for sensing a value associated with a physical quantity, the system comprising:
a sensing network comprising a transducer;
a source configured to provide an electrical signal to the sensing network;
an analog-to-digital converter coupled to the transducer, the analog-to-digital converter configured to sample an output voltage associated with the sensing network; and
one or more processors configured to determine a value of a physical quantity associated with the system based at least in part on the sampled output voltage associated with the sensing network, the value of the physical quantity being determined based at least in part on a linear approximation of a network characteristic associated with the sensing network, the linear approximation being determined by approximating a slope of a tangent of a selected point on the network characteristic to a power of two.

2. The system of claim 1, wherein the sensing network comprises a linearizing resistor coupled to the transducer.

3. The system of claim 2, wherein the linearizing resistor is coupled in series to the transducer.

4. The system of claim 2, wherein the sensing network comprises one or more resistors, operational amplifiers, capacitors, inductors or diodes.

5. The system of claim 1, wherein the analog-to-digital converter is configured to sample a voltage corresponding to a voltage drop across the transducer when the electrical signal is provided to the transducer, and to convert the sampled voltage to a digital domain.

6. The system of claim 1, wherein the transducer comprises a thermistor, pressure sensor, light dependent resistor, sound dependent sensor, strain gauge, thermocouple, resistance thermometer, or potentiometer.

7. The system of claim 1, wherein the transducer comprises a negative temperature coefficient thermistor, and wherein the physical quantity is temperature.

8. The system of claim 7, wherein the network characteristic defines a relationship between the output voltage associated with the sensing network and a temperature associated with the transducer over a range of values.

9. The system of claim 1, wherein the one or more processors are configured to determine the value of the physical quantity based at least in part on one or more bit shift operations associated with the linear approximation.

10. The system of claim 9, wherein the one or more processors are configured to determine the value of the physical quantity based at least in part on an addition operation of an offset value associated with the linear approximation.

11. The system of claim 1, wherein the selected point is a point of inflection associated with the network characteristic.

12. The system of claim 1, wherein the linear approximation is determined by approximating a slope of a tangent of a selected point on the network characteristic to the closest power of two.

13. One or more tangible, non-transitory computer-readable media storing computer-readable instructions that when executed by one or more processors cause the one or more processors to determine a value of a physical quantity associated with a sensing network based at least in part on a sampled output voltage associated with the sensing network;
wherein the sensing network comprises a transducer and a linearizing resistor coupled to the transducer, and wherein the value of the physical quantity is determined based at least in part on a linear approximation of a network characteristic associated with the sensing network, the linear approximation being determined by approximating a slope of a tangent of a selected point on the network characteristic to a power of two.

14. The one or more tangible, non-transitory computer-readable media of claim 13, wherein the transducer comprises a thermistor, and wherein the physical quantity is temperature.

15. The one or more tangible, non-transitory computer-readable media of claim 13, wherein the one or more processors are configured to determine the value of the physical quantity via one or more bit shift operations associated with the linear approximation.

16. The one or more tangible, non-transitory computer-readable media of claim 15 wherein the one or more processors are configured to determine the value of the physical quantity based at least in part on an addition operation of an offset value associated with the linear approximation.

17. A method of linearizing a network characteristic associated with a sensing network, the method comprising:
applying, by a source, an electrical signal to a sensing network, the sensing network comprising a thermistor;
converting, by an analog-to-digital converter operatively coupled to the sensing network, an output voltage associated with the sensing network to a digital representation of the output voltage; and
determining, by one or more processors, a temperature value associated with the thermistor based at least in part on a linear approximation of a network characteristic associated with the sensing network, the linear approximation of the network characteristic being determined by approximating a slope of a tangent line of a selected point on the network characteristic to a power of two.

18. The method of claim 17, wherein determining, by one or more processors, a temperature value associated with the thermistor comprises performing, by the one or more processors, one or more logic bit shift operations based at least in part on the linear approximation.

19. The method of claim 18, wherein determining, by one or more processors, a temperature value associated with the thermistor comprises performing, by the one or more processors, an addition operation of an offset value based at least in part on the linear approximation.

20. The method of claim 17, wherein the selected point on the network characteristic is a point of inflection associated with the network characteristic.
